(19) United States
(12) Patent Application Publication
(10) Pub. No.: US 2007/0274305 A1
(43) Pub. Date: Nov. 29, 2007

(54) System and method for remotely controlling device

(75) Inventor: Dennis L. Davis, Chagrin Falls, OH (US)

Correspondence Address: CALFEE HALTER & GRISWOLD, LLP, 800 SUPERIOR AVENUE, SUITE 1400, CLEVELAND, OH, 44114, US

(73) Assignee: Delta Systems, Inc.

(21) Appl. No.: 11/807,340

(22) Filed: May 25, 2007

Related U.S. Application Data
(60) Provisional application No. 60/808,988, filed on May 26, 2006.

(51) Int. Cl. H04Q 11/00

(52) U.S. Cl. 370/388

(57) ABSTRACT

A method for wireless remote control of a device is provided. In one embodiment, the method includes: transmitting a current data message to the device, the current data message including at least one data bit to control movement associated with a first positional characteristic of the device; detecting and receiving the current data message at the device; in response to a first state of the at least one data bit, energizing a first positional actuator associated with the first positional characteristic; and de-energizing the first positional actuator after not detecting a next data message within a predetermined time after having received the current data message. In this embodiment, the predetermined time is greater than a minimum time between transmission and detection of consecutive data messages, but less than ten times the minimum time between transmission and detection of consecutive data messages.

### CROSS-REFERENCE TO RELATED APPLICATIONS

This application claims the benefit of U.S. Provisional Patent Application No. 60/808,988, filed May 26, 2006 (Attorney Docket Number 30579.04007), the contents of which are fully incorporated herein by reference.

### BACKGROUND

Wireless remote control of certain devices, including searchlights, currently exists. However, position control of such devices may exhibit an undesirable amount of drift in the position of the device after a corresponding position control is de-activated or released. For example, in a current system for wireless remote control of a searchlight, a LEFT control can be activated to move the searchlight to the left. Left movement is stopped after the LEFT control is de-activated. However, typically, the LEFT control is de-activated when the searchlight is in the desired position and left movement continues for an undesirable time period. This causes the searchlight to drift beyond the desired position. Various other types of devices that are position-controlled by a wireless remote control may have similar problems with undesirable drift after a given position control is de-activated.

Based on the foregoing, there is a need for reducing the amount of drift in a device, such as a searchlight, after a position control on a wireless remote control unit associated with the device is de-activated.

### SUMMARY

In one aspect, a method for wireless remote control of a device is provided. In one embodiment, the method includes: transmitting a current data message from a remote control unit to the device, the current data message including at least one data bit to control movement associated with a first positional characteristic of the device; detecting and receiving the current data message at the device; in response to a first state of the at least one data bit, energizing a first positional actuator associated with the first positional characteristic; and de-energizing the first positional actuator after not detecting a next data message from the remote control unit within a predetermined time after having received the current data message. In this embodiment, the predetermined time is greater than a minimum time between transmission and detection of consecutive data messages, but less than ten times the minimum time between transmission and detection of consecutive data messages.

### BRIEF DESCRIPTION OF THE DRAWINGS

These and other features, aspects, and advantages of the present invention will become better understood with regard to the accompanying drawings, the description provided below, and the appended claims.

FIG. 1 is a block diagram of an exemplary embodiment of a searchlight system with wireless remote control.

FIG. 2 is a block diagram of an exemplary embodiment of a searchlight assembly.

FIG. 3 is a block diagram of an exemplary embodiment of a transmitter printed circuit board (PCB) assembly.

FIG. 4 is a block diagram of an exemplary embodiment of input devices for a transmitter PCB assembly.

FIG. 5 is a block diagram of an exemplary embodiment of a receiver PCB assembly.

FIG. 6 is a block diagram of an exemplary embodiment of a LEFT/RIGHT control circuit.

FIG. 7A is a block diagram of an exemplary embodiment of a flood lamp circuit.

FIG. 7B is a block diagram of another exemplary embodiment of a flood lamp circuit.

FIG. 8 is a diagram of an exemplary embodiment of a format for a data message for wireless communication between a transmitter PCB assembly and a receiver PCB assembly.

FIG. 9 is a diagram of an exemplary embodiment of a format for a data bit representing a “1” in a data string of a data message.

FIG. 10 is a diagram of an exemplary embodiment of a format for a data bit representing a “0” in a data string of a data message.

FIG. 11 is a diagram of an exemplary embodiment of a format for a sequence of data messages associated with wireless communication.

FIG. 12 is a flowchart of an exemplary embodiment of a transmitter process for wireless communication.

FIG. 13 is a flowchart of an exemplary embodiment of a sub-process for building a function bits portion associated with the transmitter process of FIG. 12.

FIG. 14 is a flowchart of an exemplary embodiment of a receiver process for wireless communication.

FIG. 15 is a flowchart of an exemplary embodiment of a sub-process for controlling a searchlight assembly based on a function bits portion associated with the transmitter process of FIG. 12.

FIG. 16 is a flowchart which, in combination with FIG. 15, provides another exemplary embodiment of a sub-process for controlling a searchlight assembly.

FIG. 17 is a flowchart of an exemplary embodiment of an interrupt service routine for a searchlight interrupt associated with the receiver process of FIG. 14.

FIG. 18 is a flowchart which, in combination with FIG. 17, provides another exemplary embodiment of an interrupt service routine for a searchlight interrupt.

FIG. 19 is a schematic diagram of an exemplary embodiment of a transmitter PCB assembly.

FIG. 20 is a schematic diagram of an exemplary embodiment of a receiver PCB assembly.

### DETAILED DESCRIPTION

The following paragraphs include definitions of exemplary terms used within this disclosure. Except where noted otherwise, variants of all terms, including singular forms, plural forms, and other affixed forms, fall within each exemplary term meaning. Except where noted otherwise, capitalized and non-capitalized forms of all terms fall within each meaning.

“Circuit,” as used herein, includes, but is not limited to, hardware, firmware, software or combinations of each to perform a function(s) or an action(s). For example, based on a desired feature or need, a circuit may include a software controlled microprocessor, discrete logic such as an application specific integrated circuit (ASIC), or other programmed logic device. A circuit may also be fully embodied as software. As used herein, “circuit” is considered synonymous with “logic.”

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more enumerated elements or method steps.

“Operative communication,” as used herein, includes, but is not limited to, a communicative relationship between devices, logic, or circuits. Direct electrical, electromagnetic, and optical connections and indirect electrical, electromagnetic, and optical connections are examples of such communications. Two devices are in operative communication if a signal from one is received by the other, regardless of whether the signal is modified by some other device. For example, two devices separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) 802.11 communications links, xi) satellite communication links, and xii) other wireless communication links. As another example, an electromagnetic sensor is in operative communication with a signal if it receives electromagnetic radiation from the signal. As a final example, two devices not directly connected to each other, but both capable of interfacing with a third device, e.g., a CPU, are in operative communication.

“Or,” as used herein, except where noted otherwise, is inclusive, rather than exclusive. In other words, “or” is used to describe a list of alternative things in which one may choose one option or any combination of alternative options. For example, “A or B” means “A or B or both” and “A, B, or C” means “A, B, or C, in any combination.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicated use of an exclusive “or” condition. Similarly, “A, B, or C, but no combinations” and “A, B, or C, but not the combination of A, B, and C” are examples where certain combination of alternatives are not included in the choices associate with the list.

“Processor,” as used herein, includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as RAM, ROM, EPROM, clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Signal,” as used herein, includes, but is not limited to, one or more electrical signals, analog or digital signals, one or more computer instructions, a bit or bit stream, or the like.

“Software,” as used herein, includes, but is not limited to, one or more computer readable or executable instructions that cause a computer or other electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

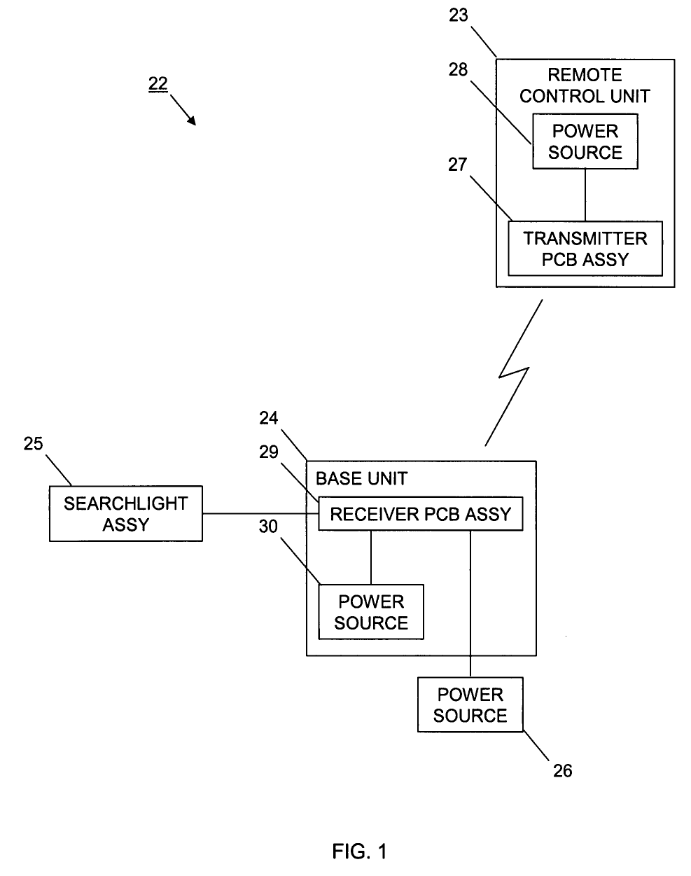

With reference to FIG. 1, an exemplary embodiment of a searchlight system 22 may include a remote control unit 23, a base unit 24, a searchlight assembly 25, and an external power source 26. The external power source 26, for example, may include a battery or line power from a power distribution system. The base unit 24 may be in operative communication with the remote control unit 23, searchlight assembly 25, and external power source 26. The remote control unit 23 may include a transmitter printed circuit board (PCB) assembly 27 and an internal power source 28. The internal power source 28, for example, may include a battery. The transmitter PCB assembly 27 may be in operative communication with the internal power source 28. The base unit 24 may include a receiver PCB assembly 29 and an internal power source 30. The internal power source 30, for example, may include a battery. The receiver PCB assembly 29 may be in operative communication with the transmitter PCB assembly 27 and the internal power source 30 or the external power source 26. The base unit 24 and searchlight assembly 25, for example, may be adapted for mounting on a watercraft or a recreational vehicle (RV). The remote control unit 23 may be adapted to control operation of the searchlight assembly 25 from any location within range of the base unit 24.

In operation, the remote control unit 23 permits an operator to control the searchlight assembly 25. For example, the operator may use the remote control unit 23 to turn on and off a flood filament or spot filament associated with a lamp in the searchlight assembly 25. Additionally, the operator may use the remote control unit 23 to rotate the lamp with respect to vertical and horizontal axes in order to direct the beam of light emitted from the lamp to a desired location. Communications between the remote control unit 23 and the base unit 24 may be wireless (e.g., radio frequency (RF), infrared (IR), etc.). Communications between the base unit 24 and the searchlight assembly 25 may be wired (e.g., copper, aluminum, fiber optic cable, etc.) or wireless. Similar systems for controlling the position of various other types of devices in addition to, or in place of, the searchlight assembly 25 are also envisioned.

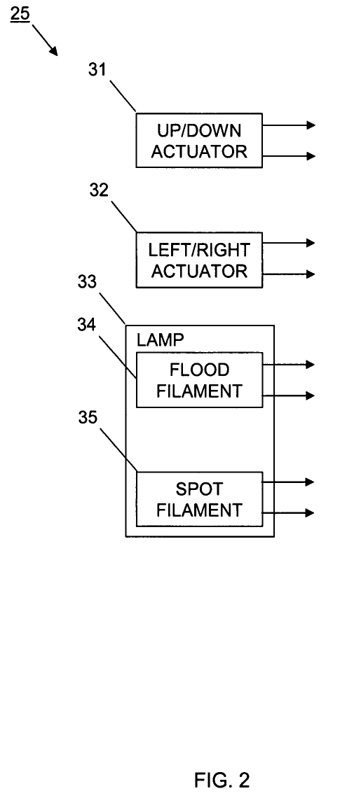

With reference to FIG. 2, an exemplary embodiment of the searchlight assembly 25 may include an UP/DOWN actuator 31, a LEFT/RIGHT actuator 32, and a lamp 33. An actuator, for example, may include a bidirectional motor, a servomotor, a stepper motor, a servomechanism, a hydraulic piston, a pneumatic actuator, an ac motor, or various other suitable types of actuators. The lamp 33 may include a flood filament 34, a spot filament 35, or both filaments. Each component of the searchlight assembly 25 may be adapted to receive a power signal and a return signal. The return signals may be independent, common, or combinations thereof. The searchlight assembly 25, for example, may include a flood searchlight similar or equivalent to a FLOJET® model no. 8135-100 flood searchlight by ITT Industries of Foothill Ranch, Calif. Alternatively, the searchlight assembly 25 may include a flood/spot searchlight similar or equivalent to a JABSCO® model no. 62022-3002H flood/spot searchlight by ITT Industries of Foothill Ranch, Calif. Similar types of devices with actuators for position control are also envisioned in place of the searchlight assembly 25.

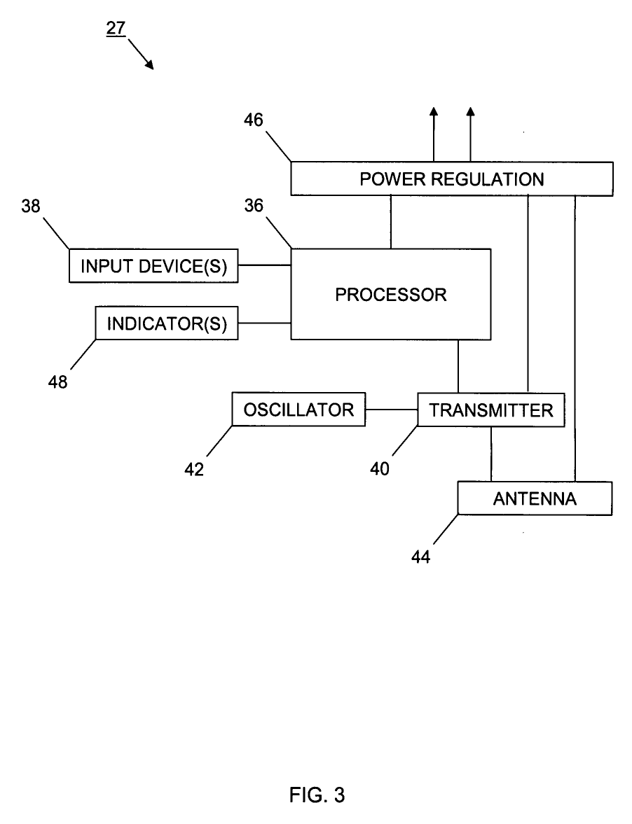

With reference to FIG. 3, an exemplary embodiment of a transmitter PCB assembly 27 may include a processor 36, one or more input devices 38, a transmitter circuit 40, an oscillator circuit 42, an antenna circuit 44, and a power regulation circuit 46. In another embodiment, the transmitter PCB assembly 27 may also include one or more indicators 48. The power regulation circuit 46 may i) receive power from the internal power source 28 (FIG. 1), ii) regulate, scale, or otherwise condition voltage and other aspects of the power signal, and iii) distribute power, for example, to the processor 36, transmitter circuit 40, antenna circuit 44, and other circuits requiring power. The processor 36 may be in operative communication with the one or more input devices 38, the transmitter circuit 40, and the one or more indicators 48. The transmitter circuit 40 may be in operative communication with the oscillator circuit 42 and antenna circuit 44. The processor 36, for example, may include a microcontroller similar or equivalent to a PIC16F630 microcontroller by Microchip Technology, Inc. of Chandler, Ariz. The transmitter circuit 40, for example, may include a transmitter similar or equivalent to a TDK5100F ASK/FSK transmitter by Infineon Technologies AG of München, Germany. The oscillator circuit 42 may establish a reference frequency (e.g., 13.56 MHz) for the transmitter circuit 40 associated with wireless transmissions (e.g., ASK or PSK modulation with a 434 MHz carrier or center frequency) from the antenna circuit 44. The antenna circuit 44, for example, may include a loop antenna.

In operation, an operator may activate one or more of the one or more input devices 38. The processor 36 may detect activations of the one or more input devices 38 and may periodically build a corresponding data message based on the current state of the one or more input devices 38 after, for example, at least one input device was activated or remains activated. The data message may be communicated to the transmitter circuit 40 for modulation over a carrier frequency. The modulated data message may be transmitted via the antenna circuit 44 to an area surrounding the remote control unit 23 (FIG. 1).

The one or more indicators 48 may include a light emitting diode (LED), lamp, display device, or any other suitable type of indicator in any combination. For example, the processor 36 may illuminate one or more of the one or more indicators to provide status information regarding the internal power source 28 (FIG. 1), information regarding current transmission of a data message, status information regarding the remote control unit 23 (FIG. 1), or other information related to the searchlight system 22 (FIG. 1). It is envisioned that the transmitter PCB assembly 27 and remote control unit 23 (FIG. 1) may be adapted to provide wireless remote control for other types of devices in addition to searchlight assemblies.

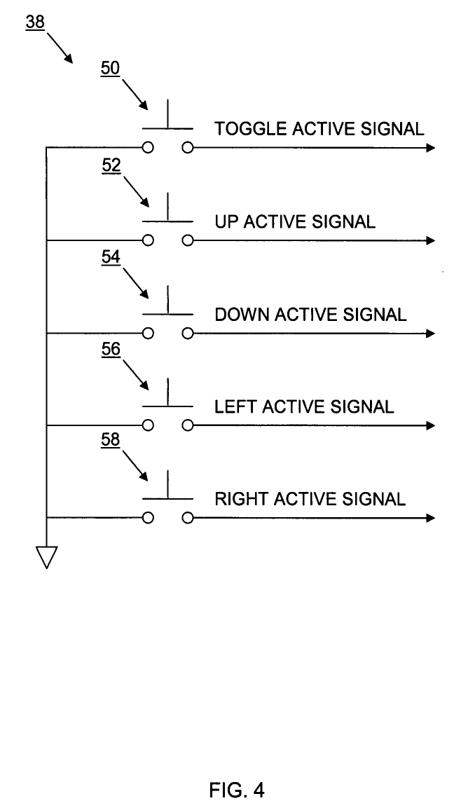

With reference to FIG. 4, an exemplary embodiment of one or more input devices 38 of a transmitter PCB assembly 27 (FIG. 3) may include a POWER switch (or POWER/LIGHT CONTROL switch) 50, an UP direction switch 52, a DOWN direction switch 54, a LEFT direction switch 56, and a RIGHT direction switch 58. Each input device may include a normally-open momentary pushbutton switch as shown in FIG. 4. The one or more input devices 38 may be adapted to receive a common ground signal and provide an independent switched control signal to the processor 36 (FIG. 3). Activation of a given input device may sink the corresponding switched control signal to ground. The searchlight system 22 (FIG. 1) may be adapted so that continued activation of the POWER switch (or POWER/LIGHT CONTROL switch) 50 for a first predetermined time causes the searchlight assembly 25 (FIG. 2) to toggle the lamp on and off. Additionally, a searchlight system 22 (FIG. 1) with a dual-filament lamp (e.g., flood/spot) may be adapted so that continued activation of the POWER switch (or POWER/LIGHT CONTROL switch) 50 for a second predetermined time, less than the first predetermined time, causes the searchlight assembly 25 (FIG. 2) to toggle between flood and spot filaments 34, 35 (FIG. 2).

With respect to operation of the searchlight system 22 (FIG. 1), after activation of a given direction switch, the searchlight assembly 25 (FIG. 2) may move in a corresponding direction. After de-activation or release of the direction switch, movement of the searchlight assembly 25 (FIG. 2) may be stopped. The one or more input devices may be arranged so that two adjacent direction switches may be activated at the same time. For example, the direction switches may be arranged below a switch cover or knob that is adapted to move in eight or more directions. Four alternating positions may be aligned with the four directional switches in a north-east-south-west (N-E-S-W) configuration and at least four alternating positions may be aligned between adjacent directional switches in a NE-SE-SW-NW configuration. The north, east, south, and west positions may correspond to up, right, down, and left movement of the searchlight assembly 25 (FIG. 2), respectively. Similarly, the NE, SE, SW, and NW positions may correspond to up/right, down/right, down/left, and up/left movement of the searchlight assembly 25 (FIG. 2), respectively. In alternate embodiments, the one or more input devices 38 may include an joystick, pushbutton joystick, one or more momentary return-to-center 3-position switches, two or more momentary 2-position rocker switches, two or more momentary 2-position toggle switches, or two or more momentary 2-position rotary switches, or equivalents thereof in any suitable combination.

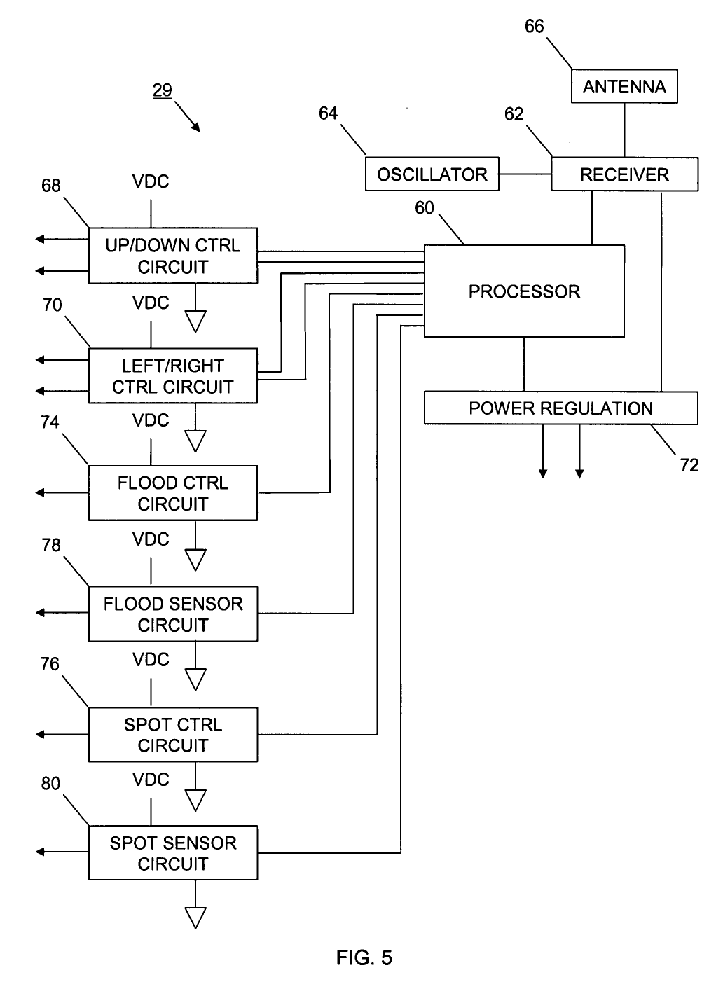

With reference to FIG. 5, an exemplary embodiment of a receiver PCB assembly 29 may include a processor 60, a receiver circuit 62, an oscillator circuit 64, an antenna circuit 66, an UP/DOWN control circuit 68, a LEFT/RIGHT control circuit 70, a power regulation circuit 72, and a flood control circuit 74. In another embodiment, the receiver PCB assembly 29 may also include a spot control circuit 76. In still another embodiment, the receiver PCB assembly 29 may include a flood sensor circuit 78 in conjunction with the flood control circuit 74. Likewise, in yet another embodiment, the receiver PCB assembly 29 may include a spot sensor circuit 80 in conjunction with the spot control circuit 76. The power regulation circuit 72 may i) receive power from the internal power source 30 (FIG. 1) or the external power source 26 (FIG. 1), ii) regulate, scale, or otherwise condition voltage and other aspects of the power signal, and iii) distribute power, for example, to the processor 60, receiver circuit 62, and other circuits requiring power. The processor 60 may be in operative communication with the receiver circuit 62, UP/DOWN control circuit 68, LEFT/RIGHT control circuit 70, flood control circuit 74, spot control circuit 76, flood sensor circuit 78, and spot sensor circuit 80.

The UP/DOWN control circuit 68 may be in operative communication with the UP/DOWN actuator 31 in a manner that provides bidirectional control of the actuator for moving the searchlight assembly 25 (FIG. 2) up or down. The LEFT/RIGHT control circuit 70 may be in operative communication with the LEFT/RIGHT actuator 32 in a manner that provides bidirectional control of the actuator for moving the searchlight assembly 25 (FIG. 2) left or right. The flood control circuit 74 may provide switched power to the flood filament 34 (FIG. 2). The spot control circuit 76 may provide switched power to the spot filament 35 (FIG. 2). The flood sensor circuit 78 may sense voltage or current in a return line from the flood filament 34 (FIG. 2). The spot sensor circuit 80 may sense voltage or current in a return line from the spot filament 35 (FIG. 2).

The processor 60, for example, may include a microcontroller similar or equivalent to a PIC16F630 by Microchip Technology, Inc. of Chandler, Ariz. The receiver circuit 62, for example, may include a receiver similar or equivalent to an ATA5744 ASK receiver by Atmel Corporation of San Jose, Calif. The oscillator circuit 64 may establish a reference frequency (e.g., 6.76 MHz) for the receiver circuit 62 associated with wireless communications (e.g., ASK or PSK modulation with a 434 MHz center or carrier frequency) received by the antenna circuit 66.

In operation, the antenna circuit 66 may periodically receive a modulated data message transmitted by the remote control unit 23 (FIG. 1) when it is within range of the base unit 24 (FIG. 1). The modulated data message may be communicated to the receiver circuit 62 where the data message is de-modulated from the carrier frequency. The processor 60 may receive the data from the receiver circuit 62, perform certain verification checks, for example, to confirm the data received is a valid data message, to confirm the data message is authorized for the searchlight assembly 25 (FIG. 2), to confirm the remote control unit 23 (FIG. 1) is authorized to control the searchlight assembly 25 (FIG. 2), and to confirm that at least certain portions of the data message (e.g., a function bits portion of a data string) are valid. After the verification checks pass, the processor 60 checks a portion of the data message (e.g., function bits portion) that may be associated with control of the searchlight assembly 25 (FIG. 2). For example, certain function bits or combinations of function bits in the data message may be interpreted by the processor 60 as commands to turn the flood filament 34 (FIG. 2) or spot filament 35 (FIG. 2) on or off, to move the searchlight assembly 25 (FIG. 2) in the left or right direction, to move the searchlight assembly 25 (FIG. 2) in the up or down direction, or combinations thereof.

More specifically, a function bit in the data message may be associated with each of the one or more input devices 38 (FIG. 4) of the remote control unit 23 (FIG. 1). For example, a first function bit may indicate whether the POWER switch (or POWER/LIGHT CONTROL switch) 50 (FIG. 4) was activated or de-activated for the current data message. Similarly, second, third, fourth, and fifth function bits may indicate whether the UP, DOWN, LEFT, or RIGHT direction switches 52, 54, 56, 58 (FIG. 4) were activated or de-activated for the current data message. It is understood that each of the first, second, third, fourth, and fifth function bits may be provided in any combination and arranged in any position or sequence within the data message. As mentioned above, up/right, up/left, down/right, and down/left combinations of the direction switches may be active in the same data message. Also, the POWER switch (or POWER/LIGHT CONTROL switch) 50 (FIG. 4) may be active with any valid combination of active direction switches.

After the processor 60 recognizes that the UP function bit is active, the UP/DOWN control circuit 68 is activated to move the UP/DOWN actuator 31 (FIG. 2) in a manner that results in upward movement of the light beam emitted by the searchlight assembly 25 (FIG. 25). Similarly, after the processor 60 recognizes the DOWN function bit is active, the UP/DOWN control circuit 68 is activated to move the UP/DOWN actuator 31 (FIG. 2) in a manner that results in downward movement of the light beam emitted by the searchlight assembly 25 (FIG. 25). Likewise, after the processor 60 recognizes the LEFT function bit is active, the LEFT/RIGHT control circuit 70 is activated to move the LEFT/RIGHT actuator 32 (FIG. 2) in a manner that results in left movement of the light beam emitted by the searchlight assembly 25 (FIG. 25). Similarly, after the processor 60 recognizes the RIGHT function bit is active, the LEFT/RIGHT control circuit 70 is activated to move the LEFT/RIGHT actuator 32 (FIG. 2) in a manner that results in right movement of the searchlight assembly 25 (FIG. 25). With regard to the lamp 33 (FIG. 2), after the processor 60 recognizes the power function bit is active, the processor 60 may check the signal to the flood control circuit 74 to determine if the circuit is active or inactive. If the flood control circuit 74 is inactive, the processor may activate the flood control circuit 74 to provide power to the flood filament 34 (FIG. 2). Conversely, if the flood control circuit 74 is active, the processor 60 may de-activate the control signal to the flood control circuit 74 to turn off the lamp 33 (FIG. 2).

In another embodiment, where the lamp 33 (FIG. 2) includes both flood and spot filaments 34, 35 (FIG. 2), the processor 60 may also include a toggle counter and processes to toggle the lamp 33 (FIG. 2) on and off if the POWER/LIGHT CONTROL switch 50 (FIG. 4) is continuously activated for a first predetermined time and toggle between flood and spot filaments 34, 35 (FIG. 2) if the POWER/LIGHT CONTROL switch 50 (FIG. 4) is continuously activated for a second predetermined time. The second predetermined time being less than the first predetermined time. If the lamp 33 (FIG. 2) is off, the processor 60 may turn on a default filament (e.g., flood filament 34 (FIG. 2)) after the POWER/LIGHT CONTROL switch 50 (FIG. 4) is continuously activated for at least the second predetermined time. If the lamp 33 (FIG. 2) is on, the processor 60 may turn the lamp filament (i.e., flood or spot) off, after the POWER/LIGHT CONTROL switch 50 (FIG. 4) is continuously activated for the first predetermined time. However, if the lamp 33 (FIG. 2) is on, the processor 60 may turn the current lamp filament (i.e., flood or spot) off and the other lamp filament (i.e., spot or flood) on, if the POWER/LIGHT CONTROL switch 50 (FIG. 4) is continuously activated for more than the second predetermined time, but less than the first predetermined time.

The processor 60 may also include an interrupt timer and corresponding service routine for an interrupt that triggers if a next data message is not received after a previous data message that initiated or continued movement of the searchlight assembly 25 (FIG. 2) before the interrupt timer expires. The interrupt service routine may de-energize any positional actuators (e.g., UP/DOWN actuator 31 or LEFT/RIGHT actuator 32) that are currently energized to ensure movement of the searchlight assembly 25 (FIG. 2) stops after the processor 60 recognizes that communication of consecutive data messages has been lost or stopped. In another embodiment, where the lamp 33 (FIG. 2) includes both flood and spot filaments 34, 35 (FIG. 2), the interrupt service routine may also include a toggle counter to determine whether a previous activation of the POWER/LIGHT CONTROL switch 50 (FIG. 4) should result in toggling between the flood and spot filaments 34, 35 (FIG. 2) or turn off the lamp 33 (FIG. 2) because the POWER/LIGHT CONTROL switch 50 (FIG. 4) along with the other one or more input devices 38 (FIG. 4) were de-activated.

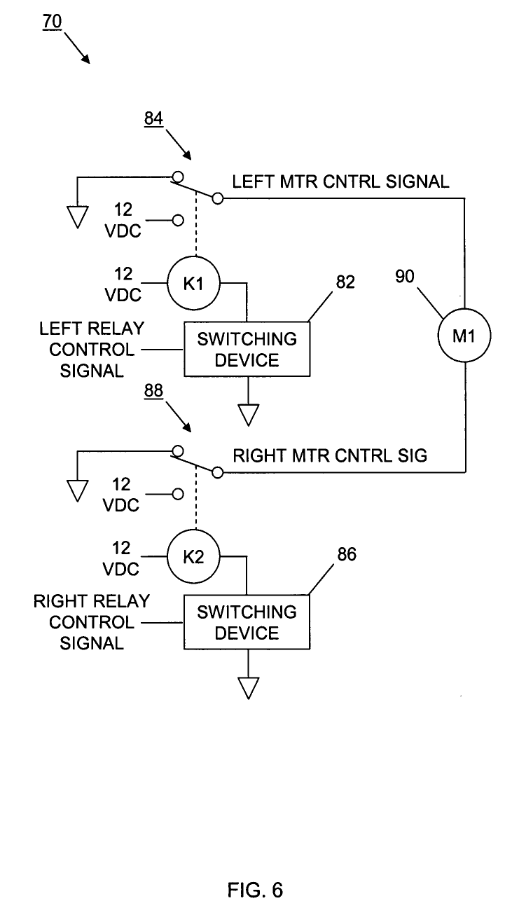

With reference to FIG. 6, an exemplary embodiment of a LEFT/RIGHT control circuit 70 may include a first switching device 82, a first relay 84, a second switching device 86, a second relay 88, and a bidirectional motor (M1) 90. Each relay (e.g., 84, 88) may include a coil (e.g., K1, K2) and a single-pole double-throw (SPDT) contact. When both relays are de-energized, the SPDT contacts are in the normally-closed (NC) contact position and both the LEFT and RIGHT motor control signals to the bidirectional motor (M1) 90 are grounded. The exemplary embodiment of the LEFT/RIGHT control circuit 70 is representative of a control circuit for controlling, for example, the rotational position of the searchlight assembly 25 (FIG. 2) or lamp 33 (FIG. 2) with respect to, for example, a vertical axis. Similarly, the exemplary embodiment of the LEFT/RIGHT control circuit 70 is representative of an exemplary embodiment of the UP/DOWN control circuit 68 for controlling, for example, the rotational position of the searchlight assembly 25 (FIG. 2) or lamp 33 (FIG. 2) with respect to, for example, a horizontal axis. The exemplary embodiment of the LEFT/RIGHT control circuit 70 is also representative of exemplary embodiments of other position control circuits for controlling bidirectional positional characteristics of one or more aspects of other types of devices.

When left movement of the light beam emitted by the searchlight assembly 25 (FIG. 2) is desired, the processor 60 (FIG. 5) may activate a LEFT relay control signal, while the RIGHT relay control signal is de-activated, to turn on the first switching device 82. This energizes the first relay 84 while the second relay 88 is de-energized. In this first scenario, the LEFT/RIGHT control circuit 70 applies 12 vdc to the LEFT motor control signal through the normally-open (NO) contact position of the first relay 84 and grounds the RIGHT motor control signal through the NC contact position of the second relay 88. This condition causes the motor to turn in a first direction that moves the searchlight assembly 25 (FIG. 2), for example, in a left direction.

Conversely, when right movement of the light beam emitted by the searchlight assembly 25 (FIG. 2) is desired, the processor 60 may activate a RIGHT relay control signal, while the LEFT relay control signal is de-activated, to turn on the second switching device 86. This energizes the second relay 88 while the first relay 84 is de-energized. In this second scenario, the LEFT/RIGHT control circuit 70 applies 12 vdc to the RIGHT motor control signal through the NO contact position of the second relay 88 and grounds the LEFT motor control signal through the NC contact position of the first relay 84. This condition causes the motor to turn in a second direction that moves the searchlight assembly 25 (FIG. 2), for example, in a right direction.

While the motor is moving, the processor 60 may de-energize the energized relay after movement of the searchlight assembly 25 (FIG. 2) is no longer desired. This removes 12 vdc and applies ground to the motor control signal associated with the energized relay. With ground applied to both LEFT and RIGHT motor control signals, electromagnetic fields associated with the motor collapse. This provides a dynamic braking effect that resists continued movement of the motor and assists in minimizing drift of the searchlight assembly 25 (FIG. 2) after movement is no longer desired.

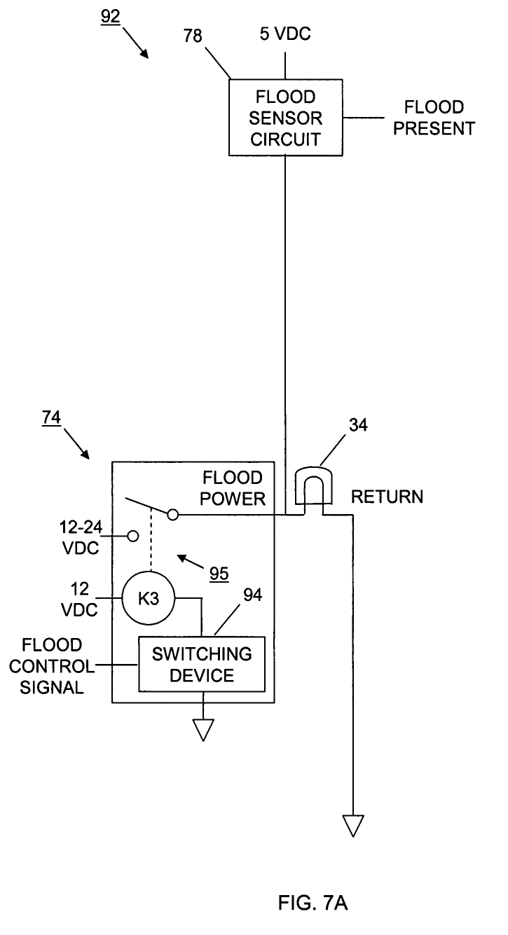

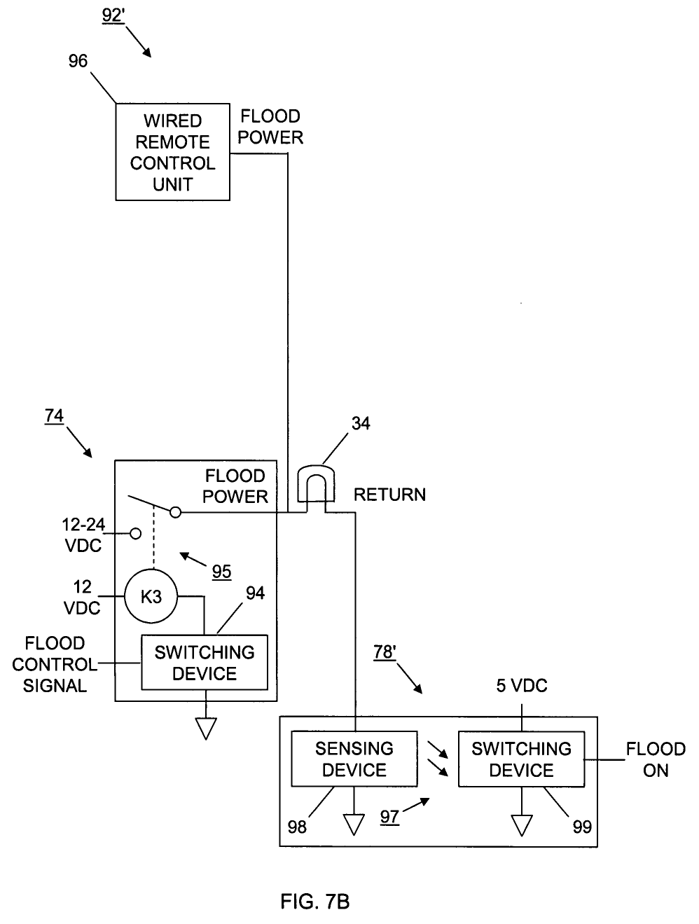

With reference to FIG. 7A, an exemplary embodiment of a flood lamp circuit 92 may include a flood control circuit 74 and a flood filament 34. The flood control circuit 74 may include a third switching device 94 and a third relay 95. The third relay 95 may include a coil K3 and a single-pole single-throw (SPST) contact. When the third relay 95 is de-energized, the SPST contact is open and no connection is applied to the flood power signal. The exemplary embodiment of the flood lamp circuit 92 is representative of an exemplary embodiment of a similar spot lamp circuit that may include the spot control circuit 76 (FIG. 5) and spot sensor circuit 80 (FIG. 5). The exemplary embodiment of the flood lamp circuit 92 is also representative of exemplary embodiments of other control circuits for controlling switched signals associated with one or more features of other types of devices.

When the flood filament 34 (FIG. 2) is desired on due to activation of the POWER switch (or POWER/LIGHT CONTROL switch) 50 (FIG. 4) on the wireless remote control unit 27 (FIG. 3), the processor 60 (FIG. 5) may activate the flood control signal to turn on the third switching device 94 which energizes the third relay 95. In this scenario, the flood control circuit 74 applies 12-24 vdc to the flood power signal through the closed SPST contact of the energized third relay 95. This condition causes the flood filament 34 to draw current and turns on the lamp 33 (FIG. 2) in a flood light mode.

In another embodiment the flood light circuit 92 may also include a flood sensor circuit 78. The flood sensor circuit 78 may include a sensing device through which a voltage (e.g., 5 vdc) may be applied to the flood filament 34. The flood sensor circuit 78 allows the processor 60 (FIG. 5) to check the “flood present” signal to determine if a flood filament 34 is present. If the flood filament 34 is present, current will flow from the flood sensor circuit 78 through flood filament 34 to ground and the “flood present” signal will be at a low logic level (e.g., 0 vdc). Conversely, if the flood filament 34 is not present, the “flood present” signal will be at a high logic level (e.g., 5 vdc). The flood sensor circuit 78 may limit current flow so that the flood filament 34 is not illuminated by the applied voltage. Accordingly, the voltage from the flood sensor circuit 78 may be continuously applied to the flood filament 34. The flood sensor circuit 78, for example, may include a diode and a resistor.

In one exemplary scenario, a searchlight assembly may include a lamp without a flood filament. In another scenario, a flood filament in a lamp may have failed. The flood sensor circuit 78 enables the processor 60 (FIG. 5) to detect these types of scenarios so that, for example, a toggling action that would result in a spot filament 35 (FIG. 2) being turned off and no flood filament 34 to turn on could be avoided. For example, the processor 60 (FIG. 5) may disable or ignore such a toggling action if the flood filament 34 is not present. In an embodiment of the searchlight system 10 (FIG. 1) with a searchlight assembly 25 (FIG. 2) that includes a dual flood/spot lamp, the processor 60 (FIG. 1) may also check the “flood on” signal or a similar “spot on” signal to determine how to respond to short activations of the POWER/LIGHT CONTROL switch in either remote control unit to toggle between flood and spot light modes and long activations to respond to by turning the lamp 33 (FIG. 2) off.

With reference to FIG. 7B, another exemplary embodiment of a flood lamp circuit 92′ may include the flood control circuit 74, flood filament 34, a flood sensor circuit 78′, and a wired remote control unit 96. The flood control circuit 74 and flood filament 34 provide the same features and operate as described above with reference to FIG. 7A. The flood sensor circuit 78′ may include an optoelectronic circuit 97. The optoelectronic circuit 97 may include a sensing device 98 that is optically coupled to a switching device 99. The optoelectronic circuit 97, for example, may include a 4N25 phototransistor optocoupler by Fairchild Semiconductor Corp. of South Portland, Me. The exemplary embodiment of the flood lamp circuit 92′ is representative of an exemplary embodiment of a similar spot lamp circuit that may include the spot control circuit 76 (FIG. 5) and spot sensor circuit 80 (FIG. 5). The exemplary embodiment of the flood lamp circuit 92′ is also representative of exemplary embodiments of other control circuits for controlling switched signals associated with one or more features of other types of devices.

With the flood sensor circuit 78′, current through the flood filament 34 flows through the sensing device 98 to ground. The current flowing through the sensing device 98 may, for example, cause an infrared (IR) emitting diode to emit IR which turns on the switching device 99. The switching device 99 may include, for example, a phototransistor that responds to the emitted IR by activating the “flood on” signal. The “flood on” signal may be checked by the processor 60 (FIG. 5) to determine whether or not current is flowing through the flood filament 34.

Like the remote control unit 23, the wired remote control unit 96 may also include circuits to apply 12-24 vdc to the flood power signal. These circuits in the wired remote control unit 96 may include a POWER switch and a flood control circuit that function in a manner similar to those described herein for the POWER switch (or POWER/LIGHT CONTROL switch) 50 (FIG. 4) and flood control circuit 74. The base unit 24 (FIG. 1) and the wired remote control unit 96 may be adapted to allow either to apply 12-24 vdc to the flood power signal and to allow both to remove 12-24 vdc from the flood power signal even though the 12-24 vdc may be applied by the other. In this embodiment, the “flood on” signal from the flood sensor circuit 78′ may be checked by the processor 60 (FIG. 5) to determine whether or not the lamp 33 (FIG. 2) is on due to current flowing through the flood filament 34 in order to determine how to respond to activation of the POWER switch.

In an embodiment of the searchlight system 10 (FIG. 1) with a searchlight assembly 25 (FIG. 2) that includes a dual flood/spot lamp, the processor 60 (FIG. 1) may also check the “flood on” signal or a similar “spot on” signal to determine how to respond to short activations of the POWER/LIGHT CONTROL switch in either the wired remote control unit 96 or the wireless remote control unit 23 (FIG. 1) to toggle between flood and spot light modes and long activations to respond to by turning the lamp 33 (FIG. 2) off.

In another embodiment, the wired remote control unit 96 may be in operative communication with the processor 60 (FIG. 5) to provide control signals from its switches directly to the processor. In this embodiment, the processor 60 (FIG. 5) and the wired remote control unit 96 may be adapted such that the base unit 24 (FIG. 1) applies 12-24 vdc to the flood power signal regardless of whether the wired remote control unit 96 or the wireless remote control unit 23 (FIG. 1) is activated.

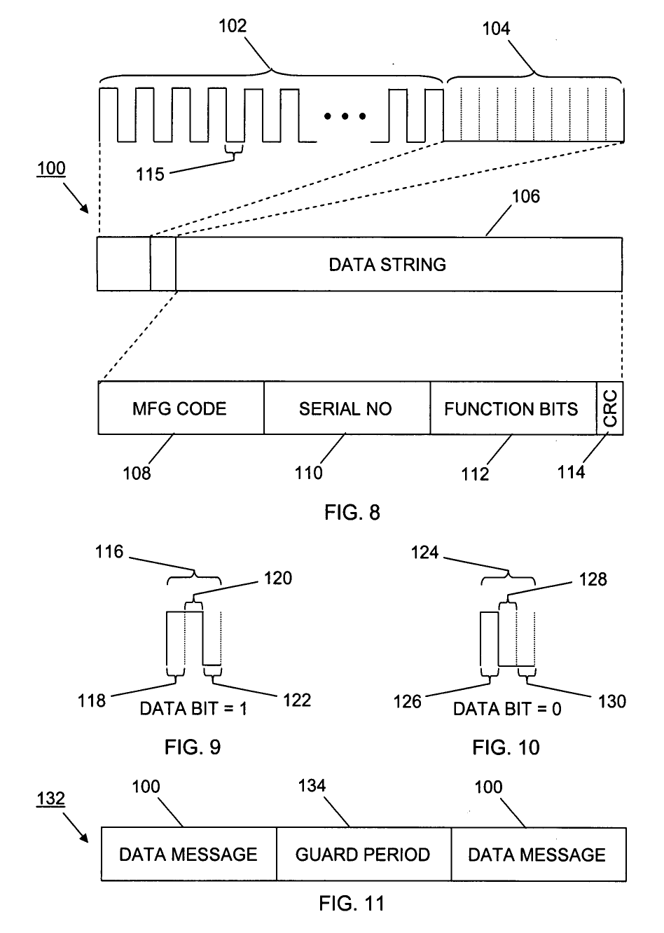

With reference to FIG. 8, an exemplary embodiment of a format for a data message 100 for wireless communication between the transmitter PCB assembly 27 (FIG. 3) and the receiver PCB ASSEMBLY 29 (FIG. 5) may include a preamble 102, a header 104, and a data string 106. The data string 106 may include a manufacturer's code portion 108, a serial number portion 110, a function bits portion 112, and a cyclical redundancy check (CRC) portion 114. The message format may be based on a pulse width modulation (PWM) transmission format, such as a KeeLoq® encoding format by Microchip Technology, Inc. of Chandler, Ariz. The message data 100 may be viewed as a series of basic time elements 115. In one embodiment, the basic time element 115 may be about 400 microseconds. In other embodiments, the basic time element 115 may be about 100, 200, or 800 microseconds. In still other embodiments, the basic time element 115 may be between 100 and 800 microseconds or greater than 800 microseconds.

The preamble 102 may include a sequence of high and low transitions forming a pulse train. In one embodiment, the preamble 102 begins with a rising edge for a first high pulse and ends with a trailing edge for a last high pulse. In one embodiment, the duration of each high and each low is the basic time element 115. In one embodiment, the duration of the preamble 102 may be thirty-one (31) basic time elements 115. In other embodiments, timing for the high and low transitions and the overall duration of the preamble 102 may be longer or shorter.

The header 104 may include a sequence of multiple basic time elements 115 in which the signal remains low. This may be viewed as a pause between the preamble 102 and data string 106. In one embodiment, the duration of the header 104 may be ten (10) basic time elements 115. In other embodiments, timing for the header 104 may be longer or shorter.

The data string 106 may include a sequence of data bits. In one embodiment, the duration of each data bit may be three (3) basic time elements 115. In other embodiments, timing for each data bit may be longer or shorter. The manufacturer's code portion 108, for example, may include eight (8) data bits and may indicate a manufacturer of the searchlight assembly 25 (FIG. 3) or a manufacturer's product line or model number associated with the searchlight assembly 25 (FIG. 3). In other embodiments, the manufacturer's code portion 108 may include more or less data bits. The serial number portion 110, for example, may include eight (8) data bits and may indicate a serial number of the remote control unit 23 (FIG. 1). In other embodiments, the serial number portion 110 may include more or less data bits.

The function bits portion 112, for example, may include eight (8) data bits and may indicate the condition of the one or more input devices 38 (FIG. 4) associated with the remote control unit 25 (FIG. 1). In other embodiments, the function bits portion 112 may include more or less data bits. Individual function bits may be associated with individual input devices 38 (FIG. 4). For example, a first function bit may be associated with the UP direction switch 52 (FIG. 4), a second function bit may be associated with the DOWN direction switch 54 (FIG. 4), a third function bit may be associated with the LEFT direction switch 56 (FIG. 4), a fourth function bit may be associated with the RIGHT direction switch 52 (FIG. 4), and a fifth function bit may be associated with the POWER switch (or POWER/LIGHT CONTROL switch) 50 (FIG. 4). The first through fifth function bits described in this example may be arranged in any sequence within the function bits portion 112. In other embodiments, any combination of the first through fifth function bits may be provided.

The CRC portion 114, for example, may include eight (8) data bits and may indicate a certain combination of function bits provided in the function bits portion 112 of the corresponding data message 100 for purposes of error checking. In other embodiments, the CRC portion 114 may include more or less data bits. The CRC portion 114 may be used by the processor 60 (FIG. 5) to detect errors in the function bits portion 112 of the corresponding data message 100.

With reference to FIG. 9, an exemplary embodiment of a format for a data bit 116 representing a “1” in the data string 106 (FIG. 8) of the data message 100 (FIG. 8) includes a first basic time element 118, a second basic time element 120, and a third basic time element 122. For a “1,” the signal transitions to high and remains high for the first and second basic time elements 118, 120. Then, the signal transitions to low and remains low for the third basic time element 122.

With reference to FIG. 10, an exemplary embodiment of a format for a data bit 124 representing a “0” in the data string 106 (FIG. 8) of the data message 100 (FIG. 8) includes a first basic time element 126, a second basic time element 128, and a third basic time element 130. For a “0,” the signal transitions to high and remains high for the first basic time element 126. Then, the signal transitions to low and remains low for the second and third basic time elements 128, 130.

With reference to FIG. 11, an exemplary embodiment of a format for a data message sequence 132 includes at least a guard period 134 between consecutive data messages 100. The guard period 134 is a minimum period between consecutive data message transmissions during which nothing is transmitted. In one embodiment, the guard period 134 may be about 30 milliseconds. In other embodiments, the guard period 134 may be about 0, 6.4, 25.6, or 76.8 milliseconds. In still other embodiments, the guard period 134 may be between 0 and 76.8 milliseconds or greater than 76.8 milliseconds. If none of the one or more input devices 38 (FIG. 4) are active after a given transmitted data message, the period between the transmitted data message and transmission of the next data message may be longer than the guard period because the next data message is not transmitted until after at least one of the one or more input devices 38 (FIG. 4) is activated.

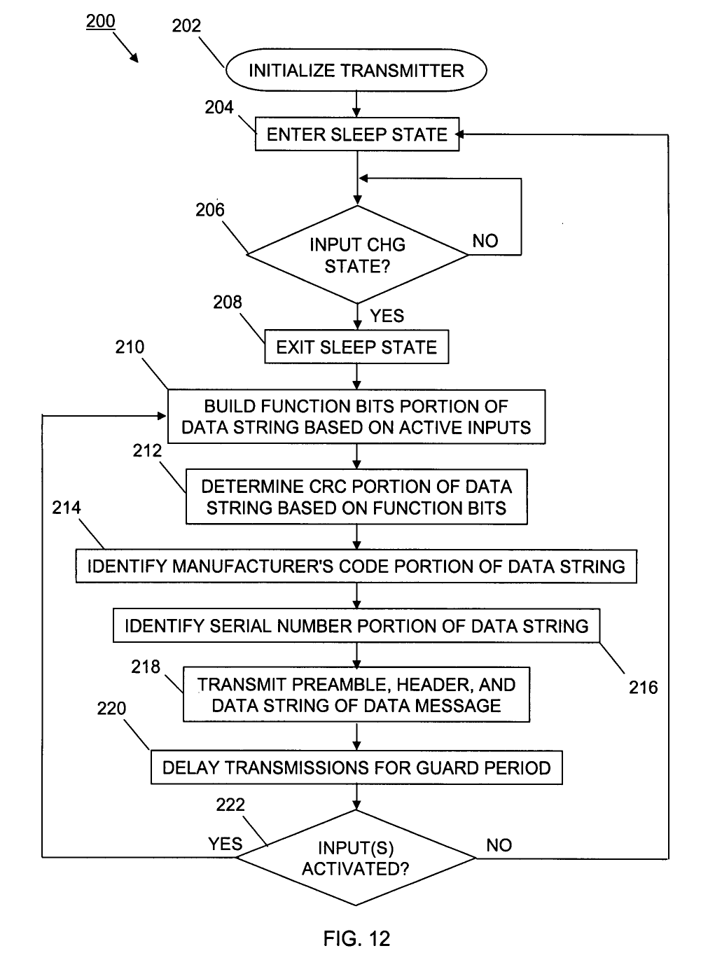

With reference to FIG. 12, an exemplary embodiment of a transmitter process 200 for wireless communication between the remote control unit 23 (FIG. 1) and base unit 24 (FIG. 1) of the searchlight system 10 (FIG. 1) begins at 202 where the transmitter PCB assembly 27 (FIG. 3) may be initialized. The process 200 being described may be implemented in software, firmware, hardware, or combinations thereof within various components of the transmitter PCB assembly 27 (FIG. 3). After initialization, at 204, the process may enter a sleep state. During the sleep state, at 206, the process may periodically determine if the one or more input devices 38 (FIG. 4) associated with the remote control unit 23 (FIG. 1) have changed state. Change of states, for example, may occur when an input device (e.g., 50, 52, 54, 56, or 58, FIG. 4) is activated. Such activations may be latched or stored for retrieval during 206. After a change of state is detected, at 208, the process may exit the sleep state.

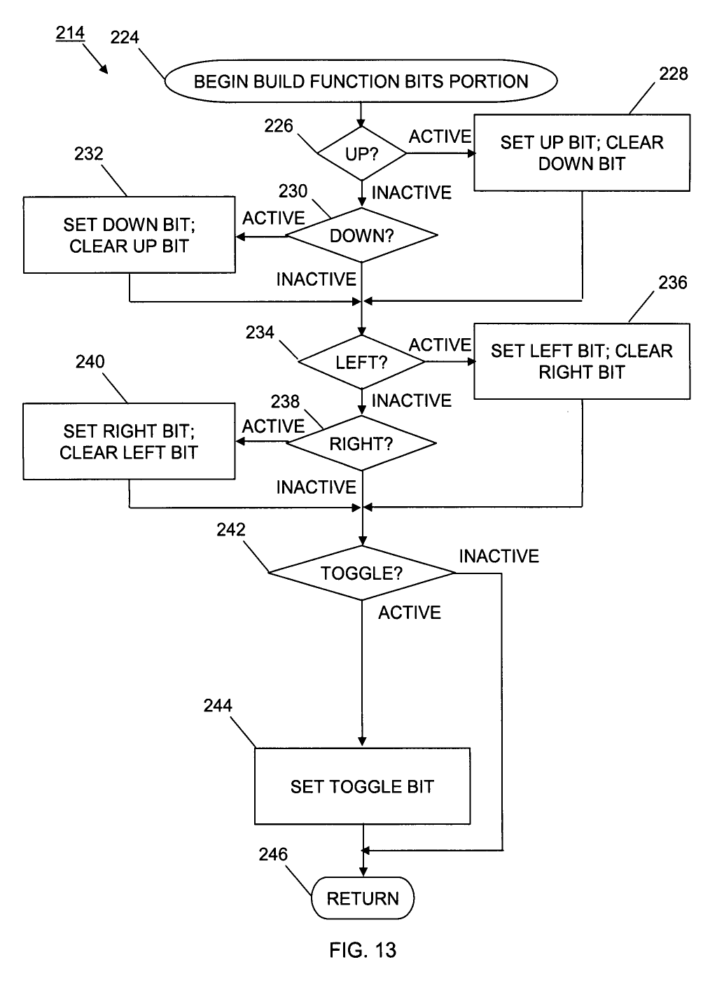

Next, at 210, the function bits portion 112 (FIG. 8) of the data string 106 (FIG. 8) may be built based on active inputs associated with the one or more input devices 38 (FIG. 4) (see FIG. 13 and its description below for additional details on building the function bits portion). At 212, a value for the CRC portion 114 (FIG. 8) of the data string 106 (FIG. 8) is determined based on the function bits. Next, at 214, a previously designated value for the manufacturer's code portion 108 (FIG. 8) of the data string 106 (FIG. 8) may be identified. At 216, a previously designated value for the serial number portion 110 (FIG. 8) of the data string 106 (FIG. 8) may be identified. Next, at 218, the preamble 102 (FIG. 8), header 104 (FIG. 8), and data string 106 (FIG. 8) of the data message 100 (FIG. 8) are transmitted by the transmitter PCB assembly 27 (FIG. 3).

At 220, further transmissions from the transmitter PCB assembly 27 (FIG. 3) are delayed for a guard period 134 (FIG. 11). Next, at 222, during the guard period 134 (FIG. 11) or shortly thereafter, the process may determine if the one or more input devices 38 (FIG. 4) associated with the remote control unit 23 (FIG. 1) have been activated. Such activations may be latched or stored for retrieval during 222. After an input activation is detected, the process may return to 210. If an input activation is not detected, the process may return to 204.

With reference to FIG. 13, an exemplary embodiment of a sub-process 210 for building the function bits portion 112 (FIG. 8) associated with the transmitter process 200 (FIG. 12) begins at 224. The sub-process 210 being described may be implemented in software, firmware, hardware, or combinations thereof within various components of the transmitter PCB assembly 27 (FIG. 3). Generally, a current state for each of the one or more input devices 38 (FIG. 4) may be determined. For example, at 226, the sub-process may determine if the UP direction switch 52 (FIG. 4) is activated. If the UP direction switch 52 (FIG. 4) is activated, at 228, the sub-process may set a first function bit associated with UP and may clear a second function bit associated with DOWN. Otherwise, at 230, the sub-process may determine if the DOWN direction switch 54 (FIG. 4) is activated. If the DOWN direction switch 54 (FIG. 4) is activated, the sub-process may set the second function bit associated with DOWN and may clear the first function bit associated with UP.

Next, at 234, the sub-process may determine if the LEFT direction switch 56 (FIG. 4) is activated. If the LEFT direction switch 56 (FIG. 4) is activated, at 236, the sub-process may set a third function bit associated with LEFT and may clear a fourth function bit associated with RIGHT. Otherwise, at 238, the sub-process may determine if the RIGHT direction switch 58 (FIG. 4) is activated. If the RIGHT direction switch 58 (FIG. 4) is activated, the sub-process may set the fourth function bit associated with RIGHT and may clear the third function bit associated with LEFT.

Next, at 242, the sub-process may determine if the POWER switch (or POWER/LIGHT CONTROL switch) 50 (FIG. 4) is activated. If the POWER switch (or POWER/LIGHT CONTROL switch) 50 (FIG. 4) is activated, at 244, the sub-process may set a fifth function bit associated with “toggling” the lamp 33 (FIG. 2) from either off to on or from on to off. In an embodiment with a dual flood/spot lamp, the fifth function bit may also be associated with “toggling” the lamp 33 (FIG. 2) between flood and spot light modes. At this point, the sub-process has reached its end and it returns 246 to the transmission process 200 (FIG. 12) with 210 completed. Likewise, if the POWER switch (or POWER/LIGHT CONTROL switch) 50 (FIG. 4) is inactive, the sub-process has reached its end and it returns 246 to the transmission process 200 (FIG. 12) with 210 completed.

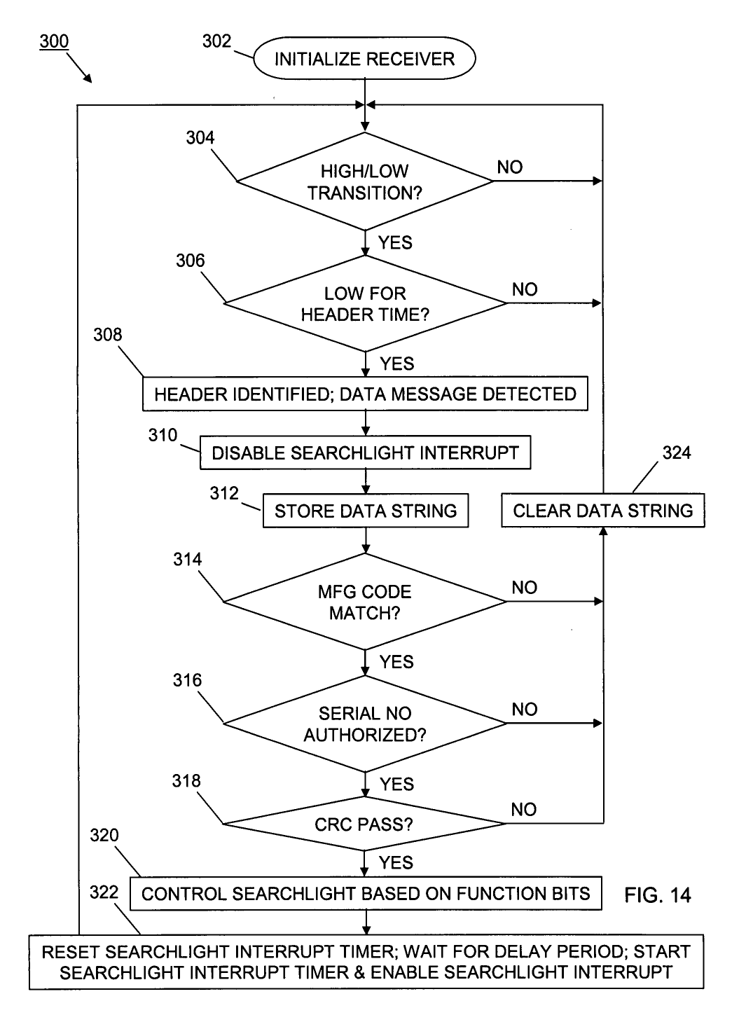

With reference to FIG. 14, an exemplary embodiment of a receiver process 300 for wireless communication between the remote control unit 23 (FIG. 1) and base unit 24 (FIG. 1) of the searchlight system 10 (FIG. 1) begins at 302 where the receiver PCB assembly 29 (FIG. 5) may be initiated. The process 300 being described may be implemented in software, firmware, hardware, or combinations thereof within various components of the receiver PCB assembly 29 (FIG. 5). After initialization, at 304, the process may periodically determine if the incoming wireless data signal has transitioned from high to low. Such transitions may be latched or stored for retrieval during 304. Generally, the process is looking for the last high-to-low transition in the preamble 102 (FIG. 8) of a data message 100 (FIG. 8) from the remote control unit 23 (FIG. 1).

After a high-to-low transition is detected, at 306, the process may determine if the incoming signal remains low for a predetermined duration of time associated with the expected duration for the header 104 (FIG. 8). In one embodiment, for example, the expected duration for the header may be about 4 milliseconds. In other embodiments, the expected duration for the header may be longer or shorter. If the incoming signal is not low for the predetermined duration, from 306, the process may return to 304. If the incoming signal is low for the predetermined duration, at 308, the process may have detected a data message 100 (FIG. 8) by identifying its header. Next, at 310, a searchlight interrupt may be disabled. At 312, the data string 106 (FIG. 8) for the data message 100 (FIG. 8) may be latched or stored for subsequent retrieval.

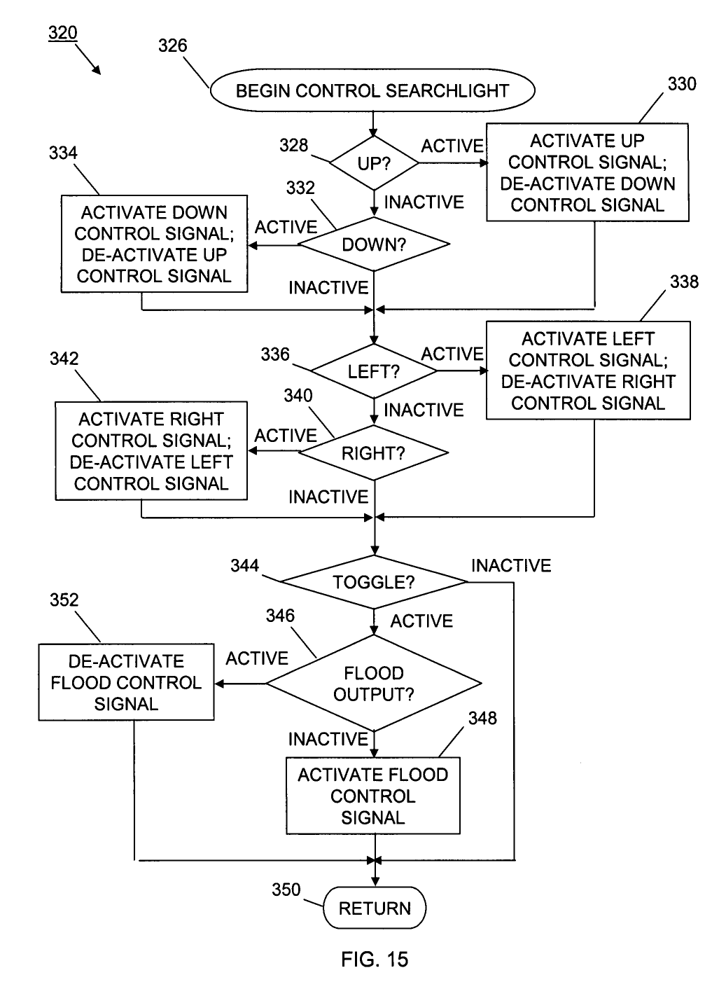

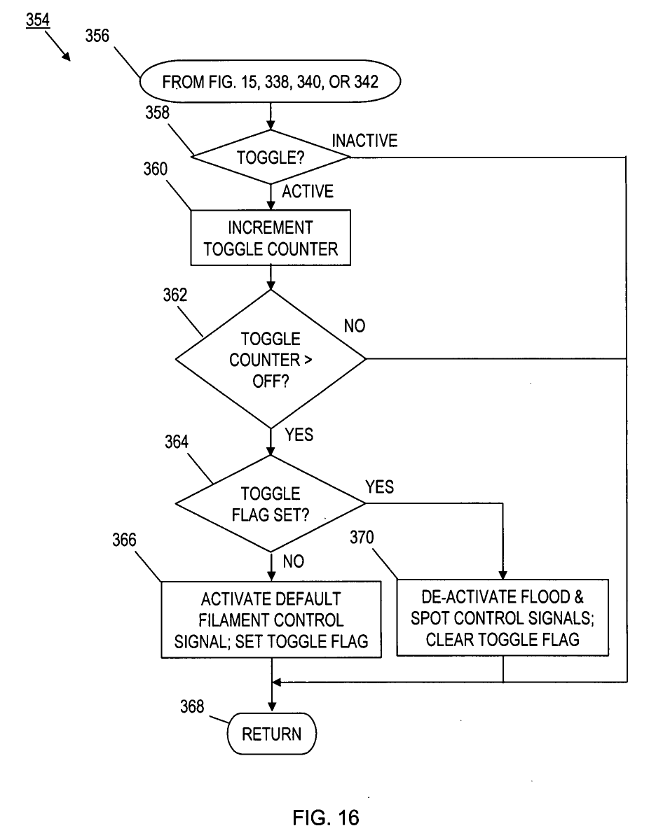

At 314, the process may determine whether the manufacturer's code portion 108 (FIG. 8) from the data string 106 (FIG. 8) matches a manufacturer's code associated with the base unit 24 (FIG. 1) or searchlight assembly 25 (FIG. 2). If the manufacturer's code portion 108 (FIG. 8) matches, at 316, the process may determine whether the serial number portion 110 (FIG. 8) from the data string 106 (FIG. 8) matches a serial number of a remote control unit 23 with which the base unit 24 (FIG. 1) is authorized to communicate. If the serial number portion 110 (FIG. 8) matches, at 318, the process may calculate a CRC based on the function bits portion 112 (FIG. 8) of the data string 106 (FIG. 8) and may determine whether the CRC portion 114 (FIG. 8) of the data string 106 (FIG. 8) matches the calculated CRC. If the CRC portion 114 (FIG. 8) matches, at 320, the process may control the searchlight assembly 25 (FIG. 2) based on the function bits portion 112 (FIG. 8) of the data string 106 (FIG. 8). See FIGS. 15 and 16 for additional detail on controlling the searchlight assembly based on the function bits portion.

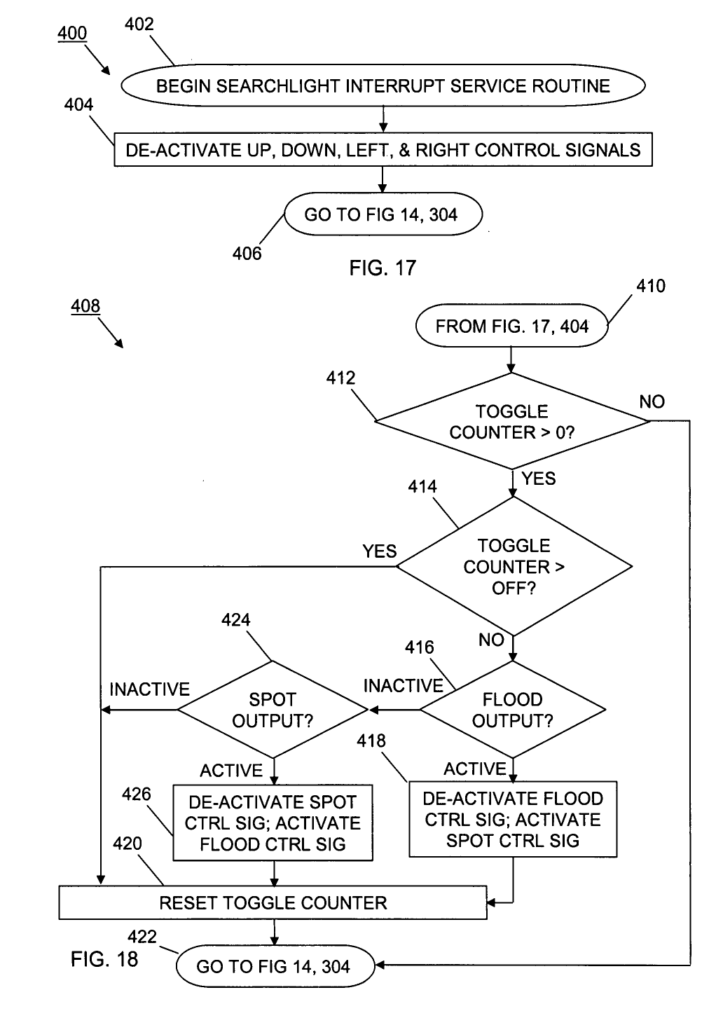

At 322, the process may reset a searchlight interrupt timer and wait for a predetermined delay time before starting the searchlight interrupt timer and enabling the searchlight interrupt. At this point, the process returns to 304. The searchlight interrupt timer, for example, may trigger the searchlight interrupt, for example, when it counts down to zero. Of course, the logic for the searchlight interrupt timer can be such that it counts up and triggers the searchlight interrupt when it reaches a predetermined value. If triggered, the searchlight interrupt may call a searchlight interrupt service routine (see FIGS. 17 and 18). Generally, the searchlight interrupt may be triggered when a next data message was not received before the searchlight interrupt timer expires.

At 314, if the manufacturer's code portion 108 (FIG. 8) does not match, the process may clear the stored data string and may return to 304. Similarly, if the serial number portion 110 (FIG. 8) does not match, the process may clear the stored data string and may return to 304. Likewise, if the CRC portion 114 (FIG. 8) does not match, the process may clear the stored data string and may return to 304.

With reference to FIG. 15, an exemplary embodiment of a sub-process 320 for controlling the searchlight assembly 25 (FIG. 2) based on the function bits portion 112 (FIG. 8) begins at 326. The sub-process 320 being described may be implemented in software, firmware, hardware, or combinations thereof within various components of the receiver PCB assembly 29 (FIG. 5). Generally, a current status of certain function bits in the function bits portion 112 (FIG. 8) may be determined. For example, at 328, the sub-process may determine if a first function bit associated with UP is activated. If the UP function bit is activated, at 330, the sub-process may activate an UP control signal and may de-activate a DOWN control signal associated with the UP/DOWN control circuit 68 (FIG. 5). Otherwise, at 332, the sub-process may determine if a second function bit associated with DOWN is activated. If the DOWN function bit is activated, at 334, the sub-process may activate a DOWN control signal and may de-activate an UP control signal associated with the UP/DOWN control circuit 68 (FIG. 5).

Next, at 336, the sub-process may determine if a third function bit associated with LEFT is activated. If the LEFT function bit is activated, at 338, the sub-process may activate a LEFT control signal and may de-activate a RIGHT control signal associated with the LEFT/RIGHT control circuit 70 (FIG. 5). Otherwise, at 340, the sub-process may determine if a fourth function bit associated with RIGHT is activated. If the RIGHT function bit is activated, at 342, the sub-process may activate a RIGHT control signal and may de-activate a LEFT control signal associated with the LEFT/RIGHT control circuit 70 (FIG. 5).

Next, at 344, the sub-process may determine if a fifth function bit associated with “toggling” the lamp 33 (FIG. 2) is activated. In one embodiment, if the “toggling” function bit is activated, at 346, the sub-process may determine if the flood control signal associated with the flood control circuit 74 (FIG. 5) is activated. In the embodiment being described, if the flood control signal is not activated, at 348, the sub-process may activate the flood control signal. At this point, the sub-process has reached its end and returns 350 to the receiver process 300 (FIG. 14) with 320 completed.

At 344, if the “toggling” function bit is not activated, the sub-process has reached its end and it returns 350 to the receiver process 300 (FIG. 14) with 320 completed.

At 346, if the flood control signal is activated, the sub-process may advance to 352 and de-activate the flood control signal. In another embodiment, 352 may also de-activate the UP control signal, DOWN control signal, LEFT control signal, and RIGHT control signal. At this point, the sub-process has reached its end and returns 350 to the receiver process 300 (FIG. 14) with 320 completed.

With reference to FIG. 16, another exemplary embodiment of a sub-process 354 for controlling the searchlight assembly 25 (FIG. 2) based on the function bits portion 112 (FIG. 8) may include 326-342 (FIG. 15) and may continue with 356. This point (i.e., 356) may be reached from 338, 340, or 342 (FIG. 15). The sub-process 354 being described may be implemented in software, firmware, hardware, or combinations thereof within various components of the receiver PCB assembly 29 (FIG. 5). The searchlight assembly 25 (FIG. 2) for the embodiment being described may include a dual filament lamp 33 (FIG. 2) with separate flood and spot filaments 34, 35 (FIG. 2). At 358, the sub-process may determine if a fifth function bit associated with “toggling” the lamp 33 (FIG. 2) is activated. If the “toggling” function bit is activated, at 360, the sub-process may increment a toggle counter. Next, at 362, the sub-process may determine if the toggle counter is greater than an “off” threshold value. In one embodiment, the “off” threshold value may be eight (8) which represents eight (8) cycles through the sub-process while the POWER switch (or POWER/LIGHT CONTROL switch) 50 (FIG. 4) is activated. The eight (8) cycles through the sub-process amounts to about one (1) second. In other words, the “off” threshold value requires an operator to hold the POWER switch (or POWER/LIGHT CONTROL switch) 50 (FIG. 4) activated for about one (1) second. In other embodiments, the logic for the toggle counter may be reversed so that it counts down from a predetermined value (e.g., eight (8)). In still other embodiments, the “off” threshold value for the toggle counter may be higher or lower.

If the toggle counter is greater than the “off” threshold value, at 364, the sub-process may determine if a toggle flag is set. If the toggle flag is not set, at 366, the sub-process may activate a default filament control signal (e.g., spot control signal) and may set the toggle flag. At this point, the sub-process has reached its end and returns 368 to the receiver process 300 (FIG. 14) with 320 completed. This first exemplary scenario reflects a condition where both flood and spot filaments 34, 35 (FIG. 2) in the lamp 33 (FIG. 2) are initially off and the POWER switch (or POWER/LIGHT CONTROL switch) 50 (FIG. 4) is currently activated. The toggling action for this scenario is to turn on the default filament (e.g., spot filament 35 (FIG. 2)) of the lamp 33 (FIG. 2).

At 364, if the toggle flag is not set, the sub-process may de-activate the flood and spot control signals and clear the toggle flag (370). In another embodiment, 370 may also de-activate the UP control signal, DOWN control signal, LEFT control signal, and RIGHT control signal. At this point, the sub-process has reached its end and returns 368 to the receiver process 300 (FIG. 14) with 320 completed. This second exemplary scenario reflects a condition where either the flood or spot filaments 34, 35 (FIG. 2) in the lamp 33 (FIG. 2) may be on when the POWER switch (or POWER/LIGHT CONTROL switch) 50 (FIG. 4) is initially activated and the POWER switch (or POWER/LIGHT CONTROL switch) 50 (FIG. 4) has been activated for a period of time that causes the toggle counter to reach the “off” threshold value. The toggling action for this scenario is to turn off the lamp 33 (FIG. 2).

At 362, if the toggle counter is not greater than the “off” threshold value, the sub-process has reached its end and returns 368 to the receiver process 300 (FIG. 14) with 320 completed. This third exemplary scenario reflects a condition where the POWER switch (or POWER/LIGHT CONTROL switch) 50 (FIG. 4) has not been activated for a period of time that exceeds the “off” threshold. However, because the POWER switch (or POWER/LIGHT CONTROL switch) 50 (FIG. 4) currently remains active, no toggling action is required until it is either de-activated or remains activated for a period of time that causes the toggle counter to reach the “off” threshold value.

At 358, if the “toggling” function bit is not activated, the sub-process has reached its end and returns 368 to the receiver process 300 (FIG. 14) with 320 completed. This fourth exemplary scenario reflects a condition where the POWER switch (or POWER/LIGHT CONTROL switch) 50 (FIG. 4) is currently de-activated. No toggling action is required for this condition.

With reference to FIG. 17, an exemplary embodiment of an interrupt service routine 400 begins at 402. The interrupt service routine 400 being described may be implemented in software, firmware, hardware, or combinations thereof within various components of the receiver PCB assembly 29 (FIG. 5). The interrupt service routine 400, for example, may service a searchlight interrupt after it has been triggered, for example, by expiration of the searchlight interrupt timer as described above in conjunction with FIG. 14. At 404, the routine may de-activate the UP control signal, DOWN control signal, LEFT control signal, and RIGHT control signal. At this point, the routine has reached its end and the receiver process 300 (FIG. 14) continues at 304.

With reference to FIG. 18, another exemplary embodiment of an interrupt service routine 408 begins at 410. This point (410) may be reached from 404 (FIG. 17). The interrupt service routine 408 being described may be implemented in software, firmware, hardware, or combinations thereof within various components of the receiver PCB assembly 29 (FIG. 5). The searchlight assembly 25 (FIG. 2) for the embodiment being described may include a dual filament lamp 33 (FIG. 2) with separate flood and spot filaments 34, 35 (FIG. 2). At 412, the routine may determine if the toggle counter is greater than zero. If the toggle counter is greater than zero, at 414, the routine may determine if the toggle counter is greater than the “off” threshold value. If the toggle counter is not greater than the “off” threshold value, at 416, the routine may determine if the flood control signal is currently active or inactive. If the flood control signal is currently active, at 418, the routine may de-activate the flood control signal and the spot control signal may be activated. Next, at 420, the toggle counter may be reset. At this point, the routine has reached its end 422 and the receiver process 300 (FIG. 14) may continue at 304.

At 416, if the flood control signal is currently inactive, the routine may advance to 424 to determine if the spot control signal is currently active or inactive. If the spot control signal is currently active, at 426, the routine may de-activate the spot control signal and the flood control signal may be activated. Next, at 420, the toggle counter may be reset. At this point, the routine has reached its end 422 and the receiver process 300 (FIG. 14) may continue at 304.

At 414, if the toggle counter is greater than the “off” threshold value, the toggle counter may be reset (420). At this point, the routine has reached its end 422 and the receiver process 300 (FIG. 14) may continue at 304.

At 412, if the toggle counter is not greater than zero, the routine has reached its end 422 and the receiver process 300 (FIG. 14) may continue at 304.

With reference to FIGS. 12-18, in one embodiment, the searchlight interrupt timer (see FIG. 14, 322) may be set or reset to about 33 milliseconds for counting down to zero. In other embodiments, the searchlight interrupt timer may start at higher or lower values. In one embodiment, the predetermined time delay (see FIG. 14, 322) may introduce about a 36 millisecond delay. In other embodiments, the predetermined time delay may be longer or shorter in duration. For example, the combination of the 36 millisecond delay and 33 millisecond searchlight interrupt timer may provide about 69 milliseconds for a next data message to be detected by the receiver PCB assembly 29 (FIG. 5) after having received the previous data message.

Generally, if the next data message is not detected at FIG. 14, 308 before the searchlight interrupt timer expires and triggers the searchlight interrupt, the searchlight interrupt may de-activate the UP/DOWN control circuit 68 (FIG. 5) and LEFT/RIGHT control circuit 60 (FIG. 5) (if the corresponding circuit is activated) to de-energize the UP/DOWN actuator 31 and LEFT/RIGHT actuator 32 (FIG. 2) (if the corresponding actuator is energized) to stop continued movement of the searchlight assembly 25 (FIG. 2). In one embodiment, the delay and timer period (e.g., about 69 milliseconds) compares to the combination of an exemplary about 30 millisecond guard period 134 (FIG. 11) between consecutive data messages, an exemplary about 12.4 millisecond preamble 102 (FIG. 8) for the next data message, and an exemplary about 4 millisecond header 104 (FIG. 8) for the next data message which amounts to about 46.4 milliseconds. In the embodiment being described, the next data message may be detected within a minimum of about 46.4 milliseconds after the end of the previous data message. Moreover, in this embodiment, if the next data message is detected in less than about 69 milliseconds after the previous data message, the receiver process 300 operates without the need for a searchlight interrupt. However, when the next data message is not detected within the about 69 milliseconds, the searchlight interrupt timer may expire. This may trigger the searchlight interrupt and the receiver process 300 (FIG. 14) may continue by performing the searchlight interrupt service routine 400 (FIGS. 17 and 18).

Moreover, due to the alternate time duration specifications of the guard period 134 (FIG. 11), preamble 102 (FIG. 8), header 104 (FIG. 8), searchlight interrupt timer (see FIG. 14, 322), and the time delay associated with the timer (see FIG. 14, 322) discussed above there are a variety of combinations that may be provided in an exemplary embodiment of the searchlight system 10 (FIG. 1) or alternate embodiments thereof. For example, in one embodiment, the time after having received the last data message that is associated with de-energizing any energized positional actuators if a next data message is not received may be less than ten times the minimum time between transmission and detection of consecutive data messages. In another embodiment, the time after having received the last data message that is associated with de-energizing any energized positional actuators if a next data message is not received may be less than five times the minimum time between transmission and detection of consecutive data messages. In still another embodiment, the time after having received the last data message that is associated with de-energizing any energized positional actuators if a next data message is not received may be less than two times the minimum time between transmission and detection of consecutive data messages.

More specifically, in one embodiment, the minimum time between transmission and detection of consecutive data messages may be less than 50 milliseconds and the time after having received the last data message that is associated with de-energizing any energized positional actuators if a next data message is not received may be less than 500 milliseconds. In another embodiment, the minimum time between transmission and detection of consecutive data messages may be less than 50 milliseconds and the time after having received the last data message that is associated with de-energizing any energized positional actuators if a next data message is not received may be less than 250 milliseconds. In still another embodiment, the minimum time between transmission and detection of consecutive data messages may be less than 50 milliseconds and the time after having received the last data message that is associated with de-energizing any energized positional actuators if a next data message is not received may be less than 100 milliseconds. In yet another embodiment, the minimum time between transmission and detection of consecutive data messages may be less than 50 milliseconds and the time after having received the last data message that is associated with de-energizing any energized positional actuators if a next data message is not received may be about 69 milliseconds.

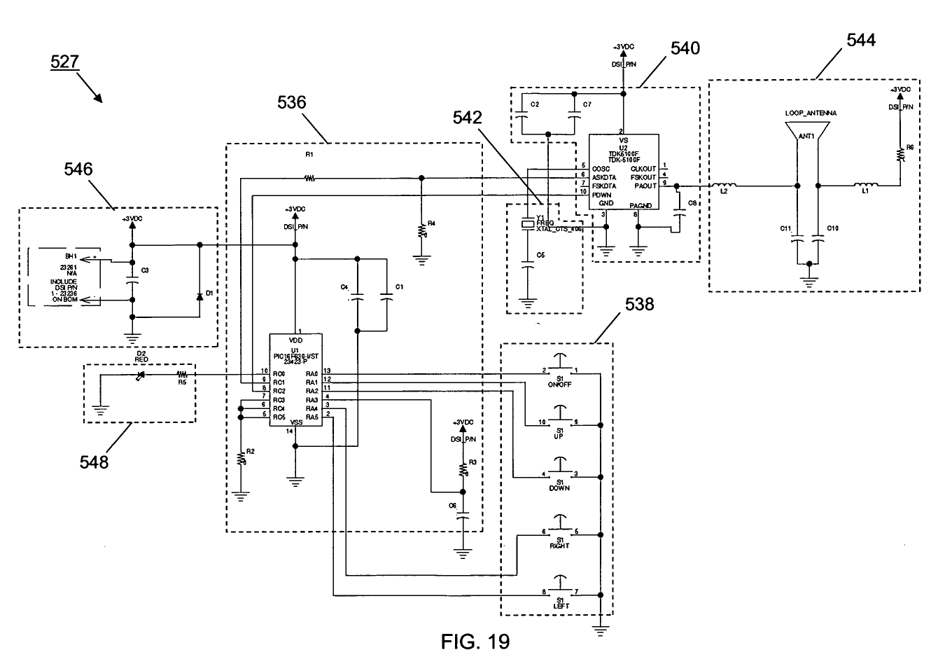

With reference to FIG. 19, an exemplary embodiment of a transmitter PCB assembly 527 may include a processor 536, one or more input devices 538, a transmitter circuit 540, an oscillator circuit 542, an antenna circuit 544, and a power regulation circuit 546. In another embodiment, the transmitter PCB assembly 527 may also include one or more indicators 548. The elements of the transmitter PCB assembly 527 operate in the same fashion as like elements of the transmitter PCB assembly 27 (FIG. 3). Like elements from FIG. 3 have a 5xx series reference numeral in FIG. 19. The schematic diagram of FIG. 19 provides exemplary embodiments (i.e., arrangement of discrete components) of each element.

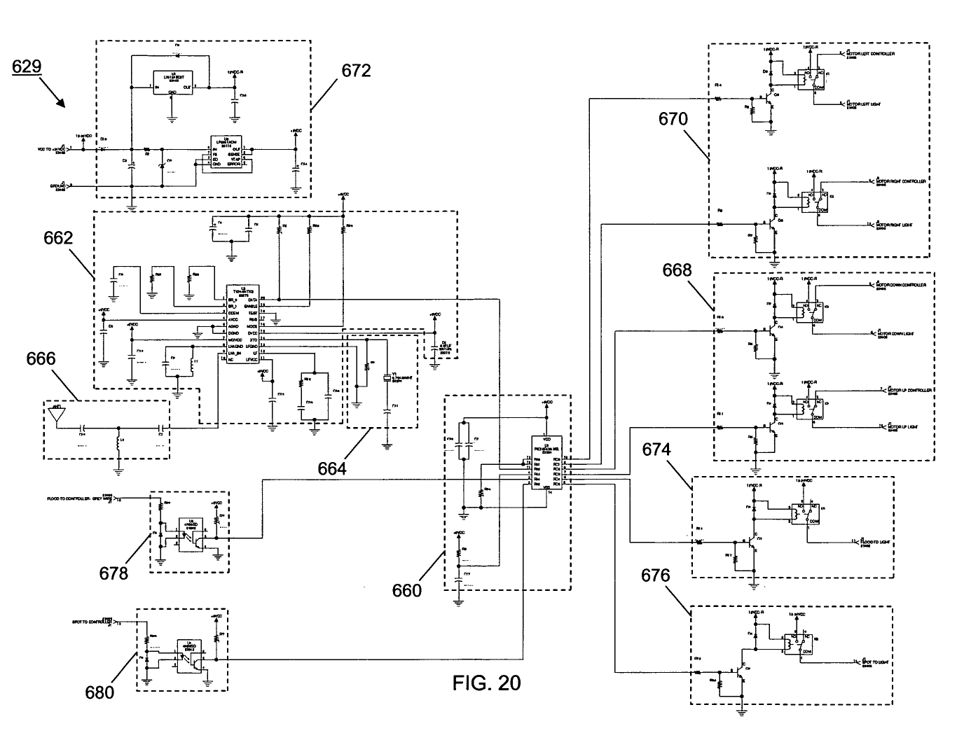

With reference to FIG. 20, an exemplary embodiment of a receiver PCB assembly 629 may include a processor 660, a receiver circuit 662, an oscillator circuit 664, an antenna circuit 666, an UP/DOWN control circuit 668, a LEFT/RIGHT control circuit 670, a power regulation circuit 672, and a flood control circuit 674. In another embodiment, the receiver PCB assembly 629 may also include a spot control circuit 676. In still another embodiment, the receiver PCB assembly 629 may include a flood sensor circuit 678 in conjunction with the flood control circuit 674. Likewise, in yet another embodiment, the receiver PCB assembly 629 may include a spot sensor circuit 680 in conjunction with the spot control circuit 676. The elements of the receiver PCB assembly 629 operate in the same fashion as like elements of the receiver PCB assembly 29 (FIG. 5). Like elements from FIG. 5 have a 6xx series reference numeral in FIG. 20. The schematic diagram of FIG. 20 provides exemplary embodiments (i.e., arrangement of discrete components) of each element.

While the present invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the present invention. More specifically, it is intended that the present invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

1. A method for wireless remote control of a device, including:
transmitting a first data message from a remote control unit to the device, the first data message including at least one data bit to control movement associated with a first positional characteristic of the device;
detecting and receiving the current data message at the device;
in response to a first state of the at least one data bit, energizing a first positional actuator associated with the first positional characteristic; and
de-energizing the first positional actuator after not detecting a next data message from the remote control unit within a first predetermined time after having received the current data message;
wherein the first predetermined time is greater than a minimum time between transmission and detection of consecutive data messages, but less than a sum of the minimum time and 470 milliseconds.

2. The method of claim 1 wherein the first predetermined time is less than a sum of the minimum time and 220 milliseconds.

3. The method of claim 1 wherein the first predetermined time is less than a sum of the minimum time and 70 milliseconds.

4. The method of claim 1 wherein the first predetermined time is less than a sum of the minimum time and about 39 milliseconds.

5. The method of claim 1, further including:
transmitting a second data message from a remote control unit to the device within a predetermined guard period after having transmitted the first data message, the second data message also including the at least one data bit at the first state to continue controlling movement associated with the first positional characteristic of the device in the same manner as the first data message;
detecting and receiving the second data message at the device;
in response to the first state of the at least one data bit in the second data message, continuing to energize the first positional actuator associated with the first positional characteristic; and
de-energizing the first positional actuator after not detecting a third data message from the remote control unit within the first predetermined time after having received the second data message.

6. The method of claim 5 wherein the first predetermined time includes a second predetermined time and a third predetermined time, the method further including:
after receiving each data message, waiting for the second predetermined time;
after the second predetermined time, starting a timer set to the third predetermined time, and enabling an interrupt that is triggered by expiration of the timer;
after detecting the corresponding data message from the remote control unit before expiration of the timer, disabling the interrupt; and
after expiration of the timer before detecting the corresponding data message from the remote control unit, de-energizing any currently energized positional actuators.

7. The method of claim 6 wherein the second predetermined time is about 36 milliseconds and the third predetermined time is about 33 milliseconds.

8. The method of claim 5 wherein the first and second data messages include another data bit at a first state to control movement associated with a second positional characteristic of the device, the method further including:
in response to the first state of the another data bit in the first data message, energizing a second positional actuator associated with the second positional characteristic; and
in response to the first state of the another data bit in the second data message, continuing to energize the second positional actuator associated with the second positional characteristic; and
de-energizing the second positional actuator after not detecting the third data message from the remote control unit within the first predetermined time after having received the second data message.

9. The method of claim 5 wherein the first data message includes another data bit at a first state to control movement associated with a second positional characteristic of the device and the second data message includes the another data bit at a second state to stop movement associated with the second positional characteristic of the device, the method further including:
in response to the first state of the another data bit in the first data message, energizing a second positional actuator associated with the second positional characteristic; and
in response to the second state of the another data bit in the second data message, de-energizing the second positional actuator associated with the second positional characteristic.

10. A method for wireless remote control of a device, including:
transmitting a current data message from a remote control unit to the device, the current data message including at least one data bit to control movement associated with a first positional characteristic of the device;
detecting and receiving the current data message at the device;
in response to a first state of the at least one data bit, energizing a first positional actuator associated with the first positional characteristic; and
de-energizing the first positional actuator after not detecting a next data message from the remote control unit within a predetermined time after having received the current data message;
wherein the predetermined time is greater than a minimum time between transmission and detection of consecutive data messages, but less than ten times the minimum time between transmission and detection of consecutive data messages.

11. The method of claim 10 wherein the predetermined time is less than five times the minimum time between transmission and detection of consecutive data messages.

12. The method of claim 10 wherein the predetermined time is less than two times the minimum time between transmission and detection of consecutive data messages.

13. The method of claim 10 wherein the predetermined time is less than 500 milliseconds and the minimum time between transmission and detection of consecutive data messages is less than 50 milliseconds.

14. The method of claim 10 wherein the predetermined time is less than 250 milliseconds and the minimum time between transmission and detection of consecutive data messages is less than 50 milliseconds.

15. The method of claim 10 wherein the predetermined time is less than 100 milliseconds and the minimum time between transmission and detection of consecutive data messages is less than 50 milliseconds.

16. The method of claim 10 wherein the predetermined time is about 69 milliseconds and the minimum time between transmission and detection of consecutive data messages is less than 50 milliseconds.

17. The method of claim 10 wherein the current data message also includes another data bit to control movement associated with a second positional characteristic of the device, the method further including:
in response to a first state of the another data bit, energizing a second positional actuator associated with the second positional characteristic; and
de-energizing the second positional actuator after not detecting the next data message from the remote control unit within a predetermined time after having received the current data message.

18. The method of claim 10 wherein the device includes a searchlight assembly and a base unit.

19. The method of claim 10 wherein the de-energizing includes providing dynamic braking to the first positional actuator.

20. The method of claim 19 wherein the dynamic braking is provided by applying ground to first and second control signals associated with the first positional actuator.

21. The method of claim 19 wherein drift of the device after the de-energizing is minimized at least in part by the dynamic braking.

22. The method of claim 10 wherein the first positional actuator is a bidirectional motor.

23. The method of claim 10 wherein drift of the device after the de-energizing is minimized at least in part by the predetermined time.

24. The method of claim 10 wherein the predetermined time is about 69 milliseconds and minimum time between transmission and detection of consecutive data messages is about 46.4 milliseconds.

25. An apparatus for wireless remote control of a device, including:
a transmitter assembly;
a receiver assembly in operative wireless communication with the transmitter assembly; and
a first positional actuator in operative communication with the receiver assembly and associated with a first positional characteristic of the device;
wherein the transmitter assembly is adapted to transmit a current data message to the receiver assembly, the current data message including at least one data bit to control movement associated with the first positional characteristic of the device;
wherein the receiver assembly is adapted to detect and receive the current data message and, in response to a first state of the at least one data bit, energizes the first positional actuator;
wherein the receiver assembly is adapted to de-energize the first positional actuator after not detecting a next data message from the transmitter assembly within a predetermined time after having received the current data message;
wherein the predetermined time is greater than a minimum time between transmission and detection of consecutive data messages, but less than ten times the minimum time between transmission and detection of consecutive data messages.

26. The apparatus of claim 25 wherein the predetermined time is less than five times the minimum time between transmission and detection of consecutive data messages.

27. The apparatus of claim 25 wherein the predetermined time is less than two times the minimum time between transmission and detection of consecutive data messages.

28. The apparatus of claim 25 wherein the predetermined time is less than 500 milliseconds and the minimum time between transmission and detection of consecutive data messages is less than 50 milliseconds.

29. The apparatus of claim 25 wherein the predetermined time is less than 250 milliseconds and the minimum time between transmission and detection of consecutive data messages is less than 50 milliseconds.

30. The apparatus of claim 25 wherein the predetermined time is less than 100 milliseconds and the minimum time between transmission and detection of consecutive data messages is less than 50 milliseconds.

31. The apparatus of claim 25 wherein the device includes a searchlight assembly.

32. An apparatus for wireless remote control of a device, including:
a transmitter assembly;
a receiver assembly in operative wireless communication with the transmitter assembly, the receiver assembly including a processor in operative communication with the transmitter assembly and a first sensor circuit in operative communication with the processor; and
a lamp in operative communication with the receiver assembly, the lamp including a first filament in operative communication with the processor and first sensor circuit;
wherein the transmitter assembly is adapted to transmit a current data message to the receiver assembly, the current data message including at least one data bit to control the lamp, a first state of the at least one data bit requesting that power be applied to the first filament and a second state of the at least one data bit requesting that power be removed from the first filament;
wherein the receiver assembly is adapted to detect and receive the current data message and, in response to the first state of the at least one data bit, the processor reads a first signal from the first sensor circuit to determine if the first filament is present.

33. The apparatus of claim 32 wherein, after determining the first filament is present, the processor activates a second signal to apply power to the first filament.

34. The apparatus of claim 32 wherein, after determining the first filament is not present, the processor does not activate a second signal that, if activated, would apply power to the first filament.

35. The apparatus of claim 32, the lamp further including:
a second filament in operative communication with the processor;
wherein the first state of the at least one data bit also requests that power be removed from the second filament and the second state of the at least one data bit also requests that power be applied to the second filament.

36. The apparatus of claim 35 wherein, after determining the first filament is present, the processor activates a second signal to apply power to the first filament and deactivates a third signal to remove power from the second filament.

37. The apparatus of claim 35 wherein, after determining the first filament is not present, the processor does not activate a second signal that, if activated, would apply power to the first filament and does not deactivate a third signal that, if deactivated, would remove power from the second filament.

38. The apparatus of claim 35, the receiver assembly further including:
a second sensor circuit in operative communication with the processor and the second filament; and
wherein, in response to the second state of the at least one data bit, the processor reads a second signal from the second sensor circuit to determine if the second filament is present.

39. The apparatus of claim 38 wherein, after determining the second filament is present, the processor activates a third signal to apply power to the second filament and deactivates a fourth signal to remove power from the first filament.

40. The apparatus of claim 38 wherein, after determining the second filament is not present, the processor does not activate a third signal that, if activated, would apply power to the second filament and does not deactivate a fourth signal that, if deactivated, would remove power from the first filament.
